(19) United States
(12) Patent Application Publication
(10) Pub. No.: US 2010/0099787 A1
(43) Pub. Date: Apr. 22, 2010

(54) VOID-CONTAINING RESIN MOLDED PRODUCT, PRODUCTION METHOD THEREFOR, AND IMAGE-RECEIVING FILM OR SHEET FOR SUBLIMATION TRANSFER RECORDING MATERIAL OR THERMAL TRANSFER RECORDING MATERIAL

(75) Inventors: Daisuke Arioka, Shizuoka (JP); Yasutomo Goto, Shizuoka (JP); Tooru Ogura, Shizuoka (JP); Hiroki Sasaki, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, TOKYO (JP)

(21) Appl. No.: 12/593,780

(22) PCT Filed: Nov. 22, 2007
(86) PCT No.: PCT/JP2007/072685

§ 371 Date: Sep. 29, 2009

(30) Foreign Application Priority Data
Mar. 30, 2007 (JP) 2007-095027
Sep. 28, 2007 (JP) 2007-256909

(51) Int. Cl. B32B 3/26; B29C 55/00

(52) U.S. Cl. 521/149; 264/41

(57) ABSTRACT

The present invention provides a void-containing resin molded product having high heat insulation properties and a method for producing such a molded product. The present invention also provides an image-receiving film or sheet that includes the void-containing resin molded product to provide favorable printing characteristics and is intended for use in a sublimation transfer recording material or a thermal transfer recording material.

The void-containing resin molded product consists of a crystalline polymer and has voids therein, wherein the resin molded product has a ratio X/Y of 0.27 or less, where X denotes a thermal conductivity (in W/mK) of the void-containing resin molded product, and Y denotes a thermal conductivity (in W/mK) of a void-free polymer molded product having the same thickness as the void-containing resin molded product and formed of the same crystalline polymer that forms the void-containing resin molded product.

### TECHNICAL FIELD

The present invention relates to a void-containing resin molded product consisting of a crystalline polymer, a production method therefor, and an image-receiving film or sheet for a sublimation transfer recording material and a thermal transfer recording material.

### BACKGROUND ART

Void-containing resin films or sheets are used as image-recording paper for thermal transfer printers or as illumination members of electronic devices by virtue of, for example, their heat-insulating properties, cushion properties, and light-transmitting properties (or light-blocking properties).

As personal computers (PCs) and network environments become increasingly available, and also electronic image recording devices such as digital cameras become widely used, hard copy techniques are needed for hard-copying images, which have been captured by these systems and products, onto sheets and other media.

One increasingly used hard copy technique is heat-sensitive transfer recording (or printers based on this technique) that achieves quiet image printing, simple operation/maintenance, and downsized/high-speed printers.

The heat-sensitive transfer recording is a printing (or image-forming) technique in which an ink ribbon, formed by, for example, coating an colored component-containing ink layer, is overlaid onto an image-receiving sheet, on which an image is to be hard-copied (or on which an image is formed in the end), and heat is applied from above by a thermal head to melt or sublimate the ink component in the ink ribbon, which in turn is transferred onto the image-receiving surface, forming an image on the surface.

When the heat-sensitive transfer recording was first introduced, the image-receiving material used was a laminate of thin polypropylene synthetic paper and natural paper, or a material consisting of a thick polypropylene synthetic paper substrate and a recording layer provided on the substrate.

However, the polypropylene synthetic paper has insufficient stiffness and thus is likely to bend and wrinkle, although it has an appropriate cushioning property and a surface smoothness which are not seen in natural paper.

Since then, image-receiving materials have been improved significantly: much effort has been devoted to improving different properties of image-receiving materials, including whiteness (required to improve sharpness of printed images), antistatic properties (required to prevent sticking of paper sheets) and anti-bending properties. Printing qualities, such as flawless printed images without involving image thinning or incomplete image formation, “clarity” of printed images and “color thickness,” are also considered important and have also been improved.

Recently, printing heads have been designed that are even smaller and more sophisticated and can ensure downsizing of printing devices (for characters and images), energy efficiency and high speed operation. As a result, less heat energy is transferred from the printing head to the image-receiving sheet. Thus, a need exists for an image-receiving sheet that requires only a small amount of heat energy to melt and sublime the ink component on an ink ribbon and transfer it to the image-receiving surface, and that can form stable images with little or no streaks, defects or non-uniformities.

One approach that has been developed to meet this need is the use of polyester resin to form an image-receiving sheet containing a significant amount of small voids (see, for example, Patent Literatures 1 to 3). The small voids contained in the image-receiving sheet serve as an air layer that provides the image-receiving sheet with increased heat insulation. This allows the effective use of the heat energy provided by the printing head in printing.

The technique described in Patent Literature 1 involves addition of inorganic fine particles to a polyester resin film, so that voids are formed within an image-receiving sheet as the inorganic fine particles are separated from the resin interface during the stretching of the resin into a film. According to the technique described in Patent Literature 1, the addition of inorganic particles can ensure whiteness of the resulting film to improve sharpness of the printed images and can provide heat insulation through the formation of voids.

However, the technique described in Patent Literature 1 requires not only sophisticated techniques and devices for dispersing fine particles, but also additives to reduce the aggregation of particles and pre-treatments of the fine particles, resulting in a complicated production process and increased cost.

Although finer particles are preferred since such particles allow formation of smaller voids and thus ensure high heat insulation, such fine particles tend to aggregate and, if they do, may cause not only non-uniformities in printed images, but also formation of small projections on the surface of the image-receiving sheet that may cause damage to the printing head or cause troubles in the operation.

Recesses may also be formed that can cause defects or streaks in the printed images. These problems are hardly addressed. In addition, if a foam layer is formed in the proximity of the surface of the image-receiving layer, the surface smoothness may be impaired due to foaming.

In another technique described in Patent Literature 2, a major resin component (such as polyester) and another resin component incompatible with the major resin are mixed/kneaded to form a two-phase structure (such as islet structure). The interface between the major resin component and the other resin component added to and kneaded with the major resin is cleaved as the resin is stretched into a film, thus resulting in the formation of voids. The size of the incompatible phase may be made uniform, so that the voids can be easily controlled and the performance of the image-receiving sheet can be improved.

When the technique described in Patent Literature 2 is used to produce an image-receiving sheet, generally, an islet structure is formed and then its interface is cleaved as the resin is stretched into a film, thus resulting in the formation of voids. When this mechanism is employed, it would be difficult to form islets small enough to provide a desired two-phase structure. As a result, the resulting voids may not be sufficiently small (i.e., difficult to control the size).

In addition, if a foam layer is formed in the proximity of the surface of the image-receiving layer, the smoothness of the surface may be lost due to foaming. Furthermore, excessively large voids may be formed, resulting in decreased printing performance and loss of luxury appearance.

Each of the techniques described in Patent Literatures 1 and 2 involves mixing into a major component other components that serve as nuclei to form voids. These components remain within the voids and may hinder the increase in heat insulation. In addition, the systems used in these techniques include a resin and an inorganic material or include different resins, and are therefore difficult to recycle.

A technique described in Patent Literature 3 involves exposing a resin film to an inert gas under pressure to impregnate the resin film with the inert gas, and stretching the resin film under atmospheric pressure to form a porous stretched resin film. Since this technique uses a gas as a source of voids, the problems involving degradation of heat insulation and recyclability can be avoided.

However, to impregnate the film with the inert gas under pressure, the entire film needs to be treated under a high pressure of several tens atm to over one-hundred atm. This requires a large-scale facility and can significantly add to the cost as compared to typical film-making apparatuses that involve melting and stretching of the film. In addition, the large volume of inert gas used in this technique requires additional equipment and countermeasures to ensure safety of operators, further adding to the cost. This technique also requires sophisticated control of conditions of the production process for ensuring uniform foaming.

### Patent Literature 1: Japanese Patent (JP-B) No. 3067557

### Patent Literature 2: Japanese Patent Application Laid-Open (JP-A) No. 2005-281396

### Patent Literature 3: JP-B No. 2006-8942

### DISCLOSURE OF INVENTION

The present invention addresses the above problems pertinent in the art and aims to achieve the following objects. Accordingly, an object of the present invention is to provide a void-containing resin molded product having high heat insulation properties and a method for producing such a molded product. Another object of the present invention is to provide an image-receiving film or sheet that includes the void-containing resin molded product to provide favorable printing characteristics and is intended for use in a sublimation transfer recording material or a thermal transfer recording material.

The present inventors conducted extensive studies to solve the above-described problems, and have found that when stretched at high speed, a polymer film consisting of polybutylene terephthalate (PBT), polyhexamethylene terephthalate (PHT) or polybutylene succinate (PBS) forms a void-containing film that has a void-containing structure (multilayered structure with several tens of layers) formed of a PBT layer (refractive index=about 1.5) and an air (void) layer (refractive index=1), a void-containing structure (multilayered structure with several tens of layers) formed of a PHT layer (refractive index=about 1.5) and an air (void) layer (refractive index=1), or a void-containing structure (multilayered structure with several tens of layers) formed of a PBS layer (refractive index=about 1.5) and an air (void) layer (refractive index=1).

The present invention has been accomplished on the basis of the finding obtained by the present inventors. Means for solving the above problems are as follows.

<1> A void-containing resin molded product consisting of:

a crystalline polymer,

wherein the void-containing resin molded product has voids therein, and has a ratio X/Y of 0.27 or less, where X denotes a thermal conductivity (in W/mK) of the void-containing resin molded product, and Y denotes a thermal conductivity (in W/mK) of a void-free polymer molded product having the same thickness as the void-containing resin molded product and consisting of the same crystalline polymer that forms the void-containing resin molded product.

<2> A void-containing resin molded product consisting of:

a crystalline polymer,

wherein the void-containing resin molded product has voids therein, and has a thermal conductivity of 0.1 (W/mK) or less.

<3> The void-containing resin molded product according to any one of <1> and <2> above, wherein the resin molded product has a void content of 3 vol % to 50 vol % and has a ratio L/r of 10 or greater, where L denotes an average length (in μm) of the voids in a direction in which the voids are aligned, and r denotes an average length (in μm) of the voids in a thickness direction of the void-containing resin molded product, which direction is perpendicular to the direction in which the voids are aligned.

<4> The void-containing resin molded product according to any one of <1> to <3> above, wherein the void-containing resin molded product consists of at least one type of the crystalline polymer, and the at least one type of the crystalline polymer has two or more different crystalline states.

<5> The void-containing resin molded product according to any one of <1> to <4> above, wherein the resin molded product consists of one type of the crystalline polymer.

<6> The void-containing resin molded product according to any one of <1> to <5> above, wherein the crystalline polymer is a polyester.

<7> The void-containing resin molded product according to any one of <1> to <6> above, wherein the voids are formed by stretching a polymer molded product consisting of the crystalline polymer at a speed of 10 mm/min to 36,000 mm/min and at a stretching temperature T(° C.) which falls within the following range:

(Tg−30)(° C.)≦T(° C.)≦(Tg+50)(° C.)

where Tg denotes a glass transition temperature (° C.) of the crystalline polymer.

<8> A method for producing the void-containing resin molded product according to any one of <1> to <7> above, the method including:

stretching a polymer molded product consisting of a crystalline polymer at a speed of 10 mm/min to 36,000 mm/min and at a stretching temperature T(° C.) which falls within the following range:

(Tg−30)(° C.)≦T(° C.)≦(Tg+50)(° C.)

where Tg denotes a glass transition temperature (° C.) of the crystalline polymer.

<9> An image-receiving film or sheet for a sublimation transfer recording material or a thermal transfer recording material, the film or sheet including:

the void-containing resin molded product according to any one of <1> to <7> above.

According to the present invention, the above existing problems can be solved through provision of a void-containing structure having high heat insulation properties and a production method therefor. According to the present invention, there is also provided an image-receiving film or sheet for a sublimation transfer recording material or a thermal transfer recording material that contains the void-containing resin molded product and has favorable printing characteristics.

### BRIEF DESCRIPTION OF DRAWINGS

FIG. 1 is a flow diagram of a biaxial stretching film-forming apparatus, showing one example of a production method of void-formed resin molded products of the present invention.

FIG. 2A is a perspective view of a void-containing resin molded product, which is used as describing the aspect ratio of the molded product in detail.

FIG. 2B is a cross-sectional view of the void-containing resin molded product of FIG. 2A taken along line A-A′, which is used for describing the aspect ratio of the molded product in detail.

FIG. 2C is a cross-sectional view of the void-containing resin molded product of FIG. 2A taken along line B-B′, which is used for describing the aspect ratio of the molded product in detail.

### BEST MODE FOR CARRYING OUT THE INVENTION

### Void-Containing Resin Molded Product

The void-containing resin molded product of the present invention consists of a crystalline polymer. If necessary, the molded product may contain other optional components.

As used herein, “molded product” may be any molded product suitably selected depending on the intended purpose. Examples include films and sheets.

### <Crystalline Polymer>

Polymers are generally divided into crystalline polymers and amorphous polymers. As opposed to what is implied by the name, crystalline polymers are not necessarily formed of crystals only. Rather, their molecular structure contains crystalline regions in which long chain molecules are aligned in a regular pattern and amorphous regions in which the molecules are not aligned regularly.

Thus, the crystalline polymer to form the void-containing resin molded products of the present invention contains at least crystalline regions in their molecular structure and may also contain amorphous regions along with the crystalline regions.

The crystalline polymer may be any crystalline polymer suitably selected depending on the intended purpose, including high-density polyethylenes, polyolefins (such as polypropylene), polyamides (PA) (such as Nylon-6), polyacetals (POM), polyesters (such as PET, PEN, PTT, PBT, PPT, PHT, PBN, PES and PBS), syndiotactic polystyrenes (SPS), polyphenylene sulfides (PPS), polyether ether ketones (PEEK), liquid crystal polymers (LCP) and fluorine resins. Of these, polyesters, syndiotactic polystyrenes (SPS) and liquid crystal polymers (LCP) are preferred from the viewpoints of their mechanical strength and readiness for production. Polyesters are particularly preferred. Two or more of these polymers may be blended together or copolymerized with one another.

While the crystalline polymer may have any melt viscosity suitably selected depending on the intended purpose, it preferably has a melt viscosity of 50 Pa·s to 700 Pa·s, more preferably 70 Pa·s to 500 Pa·s, still more preferably 80 Pa·s to 300 Pa·s. The crystalline polymer having a melt viscosity of 50 Pa·s to 700 Pa·s is preferred since the melted film extruded from a die head during the melt film-forming process is stabilized in shape and becomes suitable for making uniform films. The crystalline polymer having a melt viscosity of 50 Pa·s to 700 Pa·s is also preferred since the viscosity of the polymer becomes suitable for extrusion during the melt film-forming process and the surface of the melted film is leveled to reduce formation of projections and recesses during the film-forming process.

The viscosity can be measured by a plate-type rheometer and a capillary rheometer.

While the crystalline polymer may have any intrinsic viscosity (IV) suitably selected depending on the desired purpose, it preferably has an intrinsic viscosity of 0.4 to 1.2, more preferably 0.6 to 1.0, still more preferably 0.7 to 0.9. The crystalline polymer having an intrinsic viscosity of 0.4 to 1.2 is preferred since the resulting film has high strength and can thus be effectively stretched.

The IV value can be measured by an Ubbelohde viscometer.

While the crystalline polymer may have any melting point (Tm) suitably selected depending on the desired purpose, it preferably has a melting point of 40° C. to 350° C., preferably 100° C. to 300° C., still more preferably 100° C. to 260° C. The crystalline polymer having a melting point of 40° C. to 350° C. is preferred since it can maintain its shape in a temperature range within which the polymer is expected to be generally used. This temperature range is also preferred since the polymer can be formed into uniform films without using special techniques that are otherwise required for high temperature processing.

The melting point can be measured by a differential scanning calorimeter (DSC).

### —Polyester Resin—

The term “polyester” (hereinafter referred to as a “polyester resin”) is a collective term for polymers in which the polymer backbone is primarily formed by ester bonds. Thus, the polyester resins suitable for the above-described crystalline polymers include not only the above-described polyesters (i.e., polyethylene terephthalate (PET), polyethylene naphthalate (PEN), polytrimethylene terephthalate (PTT), polybutylene terephthalate (PBT), polypentamethylene terephthalate (PPT), polyhexamethylene terephthalate (PHT), polybutylene naphthalate (PBN), polyethylene succinate (PES) and polybutylene succinate (PBS)), but also any polymer obtained through polycondensation of a dicarboxylic acid component with a diol component.

The dicarboxylic acid component may be any dicarboxylic acid suitably selected depending on the intended purpose, including aromatic dicarboxylic acids, aliphatic dicarboxylic acids, alicyclic dicarboxylic acids, oxycarboxylic acids and polyfunctional acids. Of these, aromatic dicarboxylic acids are particularly preferred.

Preferred examples of the aromatic dicarboxylic acids include terephthalic acid, isophthalic acid, diphenyl dicarboxylic acid, diphenyl sulfone dicarboxylic acid, naphthalene dicarboxylic acid, diphenoxyethane dicarboxylic acid and 5-sodium sulfoisophthalic acid. Of these, terephthalic acid, isophthalic acid, diphenyl dicarboxylic acid and naphthalene dicarboxylic acid are preferred, with terephthalic acid, diphenyl dicarboxylic acid and naphthalene dicarboxylic acid being particularly preferred.

Examples of the aliphatic dicarboxylic acids include oxalic acid, succinic acid, eicosanoic acid, adipic acid, sebacic acid, dimer acid, dodecandionic acid, maleic acid and fumaric acid. Examples of the alicyclic dicarboxylic acids include cyclohexane dicarboxylic acid. Examples of the oxycarbxylic acids include p-oxybenzoic acid. Examples of the polyfunctional acids include trimellitic acid and pyromellitic acid. Of these, aliphatic dicarboxylic acids and alicyclic dicarboxylic acids, succinic acid, adipic acid and cyclohexane dicarboxylic acid are preferred, with succinic acid and adipic acid being particularly preferred.

The diol component may be any diol suitably selected depending on the intended purpose, including aliphatic diols, alicyclic diols, aromatic diols, diethylene glycol and polyalkylene glycol. Of these, aliphatic diols are particularly preferred.

Examples of the aliphatic diols include ethylene glycol, propane diol, butane diol, pentane diol, hexane diol, neopentyl glycol and triethylene glycol. Of these, propane diol, butane diol, pentane diol and hexane diol are particularly preferred. Examples of the alicyclic diols include cyclohexane dimethanol. Examples of the aromatic diols include bisphenol A and bisphenol S.

While the polyester resin may have any melt viscosity suitably selected depending on the intended purpose, it preferably has a melt viscosity of 50 Pa·s to 700 Pa·s, more preferably 70 Pa·s to 500 Pa·s, still more preferably 80 Pa·s to 300 Pa·s. Although a higher melt viscosity is more likely to result in the formation of voids during stretching of the film, the polyester resin having a melt viscosity of 50 Pa·s to 700 Pa·s is preferred since such a resin can be easily extruded during the film-forming process and can form a stable flow of resin that is less likely to stagnate. As a result, the quality of the film can be stabilized. The polyester resin having a melt viscosity of 50 Pa·s to 700 Pa·s is also preferred since the tension is suitably maintained during stretching of the film, so that the film can be stretched uniformly and is less likely to tear. Another reason why the polyester resin having a melt viscosity of 50 Pa·s to 700 Pa·s is preferred is that such a resin can improve physical properties of the film. For example, such a resin allows the shape of the melted film extruded from a die head during the film-forming process to be easily maintained, so that the film can be shaped in a stable manner and the resulting products become less susceptible to damage.

While the polyester resin may have any intrinsic viscosity (IV) suitably selected depending on the desired purpose, it preferably has an intrinsic viscosity of 0.4 to 1.2, more preferably 0.6 to 1.0, still more preferably 0.7 to 0.9. Although a higher IV is more likely to result in the formation of voids during stretching of the film, the polyester resin having an IV of 0.4 to 1.2 is preferred since such a resin can be easily extruded during the film-forming process and can form a stable flow of resin that is less likely to stagnate. As a result, the quality of the film can be stabilized. The polyester resin having an IV of 0.4 to 1.2 is also preferred since the tension is suitably maintained during stretching of the film, so that the film can be stretched uniformly, resulting in a decreased load applied to the system. Another reason why the polyester resin having an IV of 0.4 to 1.2 is preferred is that such a resin can improve physical properties of the product, making it less susceptible to damage.

While the polyester resin may have any melting point suitably selected depending on the desired purpose, it preferably has a melting point of 150° C. to 300° C., more preferably 180° C. to 270° C., to ensure heat resistance and formability of the resin into the film.

The polyester resin may be composed of a single type of the dicarboxylic acid component and a single type of the diol component that are polymerized together to form a polymer, or it may be composed of two or more types of the dicarboxylic acid component and/or the diol component that are copolymerized to form a polymer. Alternatively, two or more types of polymers may be blended together to provide the polyester resin.

When two or more types of polymers are blended together, the auxiliary polymer to be added to the main polymer preferably has a melt viscosity and intrinsic viscosity that are close to those of the main polymer and is preferably added in a smaller amount relative to the main polymer to improve the physical properties of the polyester resin in the film-forming process or the melt extrusion and to thus facilitate the extrusion of the polyester resin.

When desired, a resin other than polyester resins may be added to the polyester resin to improve the fluidity of the polyester resin, to control the light transmittance of the polyester resin, or to improve the adhesion of the polyester resin to a coating solution.

As described above, voids can be formed in the void-containing resin molded product of the present invention in a simple step without adding inorganic fine particles, incompatible resins and other void-forming agents that were used in prior art technologies. Moreover, the void-containing resin molded product of the present invention does not require special facilities for dissolving an inert gas in the resin. The production method of the void-containing resin molded product will be described below.

When necessary, the void-containing resin molded product may contain other optional components that do not affect the formation of voids. Such other components include a heat resistance stabilizer, an antioxidant, an organic lubricant, a nucleating agent, a dye, a pigment, a dispersing agent, a coupling agent and an optical brightening agent. Whether these components can contribute to the formation of voids can be determined by detecting the presence of other components than the crystalline polymer (such as those described below) either within the voids or at the interface of the voids.

The antioxidant may be any antioxidant suitably selected depending on the desired purpose. For example, a known hindered phenol may be added. Among such hindered phenols are antioxidants marketed under the trade names of IRGANOX 1010, SMILIZER BHT and SMILIZER GA-80.

The antioxidant may be used as a primary antioxidant in conjunction with a secondary antioxidant. Examples of secondary antioxidants include antioxidants marketed under the trade names of SMILIZER TPL-R, SMILIZER TPM and SMILIZER TP-D.

The optical brightening agent may be any optical brightening agent suitably selected depending on the desired purpose, including those marketed under the trade names of UVITEX, OB-1, TBO, KEIKOL, KAYALITE, LEUCOPOOR and EGM. These optical brightening agents may be used individually or in combination. The optical brightening agent gives the void-containing resin molded product a clear, bluish white color, providing a luxurious appearance.

### <Void>

The void-containing resin molded product of the present invention contains voids that are characteristic in their amount in the resin molded product (hereinafter referred to as a “void content”) and their aspect ratio.

The term “void” as used herein means a vacuum domain or a gas phase domain present within the resin molded product.

The void content is defined as the total volume of voids present within the resin molded product with respect to the sum of the total volume of the solid phase of the resin molded product and the total volume of the voids present within the resin molded product.

The void content may take any value as long as the advantage effects of the present invention are not impaired. Such void content may be suitably selected depending on the intended purpose, and is preferably 3 vol % or more and 50 vol % or less, more preferably from 5 vol % to 40 vol %, still more preferably from 10 vol % to 30 vol %.

The void content may be calculated based on the measured specific gravity.

Specifically, the void content can be determined by the following equation (1):

Void content (%)={1−(density of void-containing resin molded product after stretching)/(density of void-containing resin molded product before stretching)} (1)

The aspect ratio is a ratio defined as L/r, where L denotes an average length of the voids (in μm) in a direction in which the voids are aligned, and r denotes an average length of the voids (in μm) in a thickness direction which is perpendicular to the direction in which the voids are aligned.

The aspect ratio may take any value as long as the advantageous effects of the present invention are not impaired. Such an aspect ratio may be suitably selected depending on the desired purpose and is preferably 10 or greater, more preferably 15 or greater, still more preferably 20 or greater.

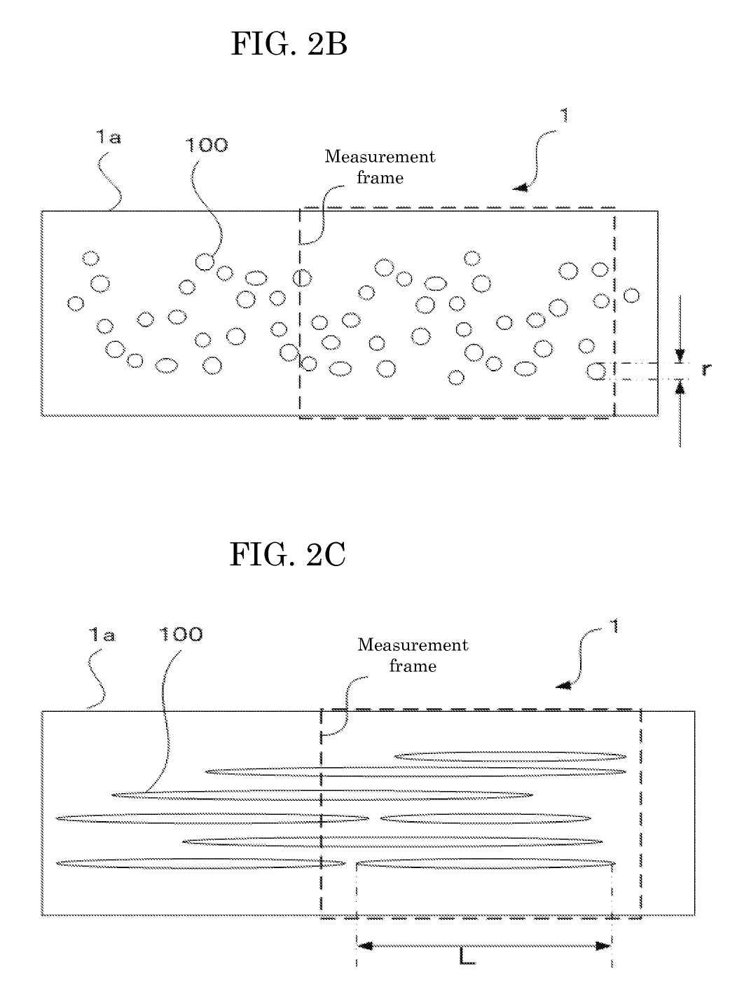

FIGS. 2A to 2C each are used for describing the aspect ratio in detail, with FIG. 2A being a perspective view of a void-containing resin molded product, FIG. 2B being a cross-sectional view of the void-containing resin molded product of FIG. 2A taken along line A-A′, and FIG. 2C is a cross-sectional view of the void-containing resin molded product of FIG. 2A taken along line B-B′.

During the production process of void-containing resin molded products, the voids are generally aligned along a first stretching direction. Thus, what is meant by “average length of the voids (r) (in μm) in a thickness direction which is perpendicular to a direction in which the voids are aligned” corresponds to the average thickness r of voids 100 (see FIG. 2B) as viewed in a cross-section that is perpendicular to the surface 1a of the void-containing resin molded product 1 and perpendicular to the first stretching direction (cross-section taken along line A-A′ of FIG. 2A). Likewise, what is meant by “average length of voids (L) (in μm) in a direction in which the voids are aligned” corresponds to the average L of voids 100 (see FIG. 2C) as viewed in a cross-section that is perpendicular to the surface of the void-containing resin molded product and parallel to the first stretching direction (cross-section taken along line B-B′ of FIG. 2A).

When the void-containing resin molded product is stretched only in one direction, the first stretching direction refers to that direction. In general, the resin molded product is stretched longitudinally along the direction of its flow. Thus, the first stretching direction typically corresponds to this longitudinal stretching direction.

When the void-containing resin molded product is stretched in two or more directions, the first stretching direction refers to at least one direction in which the resin molded product is stretched in order to form voids. In general, when the resin molded product is stretched in two or more directions, the resin molded product is also stretched longitudinally along the direction in which the resin molded product flows during the production. Since voids are formed by this longitudinal stretching, the first stretching direction corresponds to this longitudinal stretching direction.

The average length r of the voids (in μm) in a thickness direction which is perpendicular to a direction in which the voids are aligned can be measured from an image obtained by an optical microscope or electron microscope. Similarly, the average length L of voids (in μm) in a direction in which the voids are aligned can also be measured from an image obtained by an optical microscope or electron microscope.

The presence of voids in the void-containing resin molded product improves many of its properties, including thermal conductivity. In other words, the properties of the void-containing resin molded product, including thermal conductivity, can be adjusted as desired by changing the form of voids present in the void-containing resin molded product.

### —Thermal Conductivity—

The void-containing resin molded product preferably has a thermal conductivity of 0.1 (W/mK) or less, more preferably 0.09 (W/mK) or less, still more preferably 0.08 (W/mK) or less.

A suitable thermal conductivity of the void-containing resin molded product can be defined as a relative value. Specifically, given that X (W/mK) is the thermal conductivity of the void-containing resin molded product, and Y (W/mK) is the thermal conductivity of a void-free polymer molded product that has the same thickness as the void-containing resin molded product and is formed of the same crystalline polymer as that forming the void-containing resin molded product, the ratio X/Y is preferably 0.27 or less, more preferably 0.2 or less, still more preferably 0.15 or less.

The thermal conductivity can be calculated as the product of the thermal diffusivity, the specific heat and the density. In general, the heat diffusivity can be measured by the laser flash method (using, for example, TC-7000 manufactured by The Optronics, Co., Ltd.). The specific heat can be measured by using a DSC according to a method described in JIS K7123. The density can be calculated by measuring the mass of the resin molded product in a predetermined area and its thickness.

Also, the void-containing resin molded product has high surface smoothness since it is free of inorganic fine particles, incompatible resins, inert gases and other components for forming voids that were used in prior art technologies.

While the void-containing resin molded product may have any surface smoothness that is suitably selected depending on the desired purpose, it preferably has a surface smoothness Ra of 0.3 μm or less, more preferably 0.25 μm or less, particularly preferably 0.1 μm or less.

### (Production Method of Void-Containing Resin Molded Product)

One method of producing the void-containing resin molded product includes at least the step of stretching a polymer molded product and other optional steps, such as film-forming step.

The above-described polymer molded product refers to a void-free molded product consisting of the above-described crystalline polymer. Examples of the polymer molded products include polymer films and polymer sheets.

### —Stretching Step—

In the stretching step, the polymer molded product is stretched at least monoaxially. As the polymer molded product is stretched, voids aligned along the first stretching direction are formed within the polymer molded product. As a result, a void-containing resin molded product can be obtained.

One reason why the voids are formed by stretching the polymer molded product is believed to be that at least one of the crystalline polymers that form the polymer molded product is composed of different states of crystals, including a phase containing crystals that can hardly be stretched during stretching of the polymer molded product, such that the resin between the hard crystals is torn as the polymer molded product is stretched, providing the source of voids.

The formation of voids by stretching can occur not only in a polymer molded product composed of one crystalline polymer, but also in a polymer molded product composed of two or more crystalline polymers that are blended or copolymerized together.

The polymer molded product can be stretched by any technique as long as the advantageous effects of the present invention are not impaired. Examples of such techniques include monoaxial stretching, successive biaxial stretching and simultaneous biaxial stretching. Regardless of the type of stretching technique used, it is preferred that the polymer molded product be stretched longitudinally along the direction in which the molded product flows during the production process.

In general, the number of stretching steps and the stretching speed during longitudinal stretching can be adjusted by changing the combination of rolls and the difference in speed among rolls.

While the longitudinal stretching may be carried out in any number of steps (i.e., one or more steps), it is preferred that the polymer molded product be longitudinally stretched in two or more steps in order to ensure stable, high-speed stretching and also in view of the production yield and the limitations of the stretching machine. The stretching carried out in more than two steps is also advantageous in that the occurrence of necking can be confirmed in the first step prior to the stretching in the second step for forming voids.

### —Stretching Speed—

The longitudinal stretching may be carried out at any speed as long as the advantageous effects of the present invention are not impaired. While such a speed may be suitably selected depending on the desired purpose, it is preferably from 10 mm/min to 36,000 mm/min, more preferably from 800 mm/min to 24,000 mm/min, still more preferably from 1,200 mm/min to 12,000 mm/min. Preferred are 10 mm/min or greater stretching speeds, since sufficient necking can occur at such a speed. Likewise, 36,000 mm/min or less stretching speeds are preferred since the polymer molded product can be stretched uniformly at such a speed, so that the resin is less likely to tear and cost reduction is possible since large stretching apparatuses intended for high-speed stretching are not necessary. Thus, stretching speeds of from 10 mm/min to 36,000 mm/min are preferred since not only can sufficient necking occur at such a speed, but the polymer molded product can also be stretched uniformly, so that the resin is less likely to tear and cost reduction is possible since large stretching apparatuses intended for high-speed stretching are not necessary.

More specifically, the stretching speed is preferably from 1,000 mm/min to 36,000 mm/min, more preferably from 1,100 mm/min to 24,000 mm/min, still more preferably from 1,200 mm/min to 12,000 mm/min for the single step stretching.

For the two-step stretching, the first stretching step preferably serves as a preparatory stretching step intended primarily for the purpose of inducing necking. The stretching speed of preparatory stretching is preferably from 10 mm/min to 300 mm/min, more preferably from 40 mm/min to 220 mm/min, still more preferably from 70 mm/min to 150 mm/min.

In the two-step stretching, the stretching speed of the second stretching step following the preparatory stretching (i.e., first stretching step) for inducing necking preferably differs from the stretching speed of the preparatory stretching. The stretching speed of the second stretching step after necking has been induced in the preparatory stretching is preferably from 600 mm/min to 36,000 mm/min, more preferably from 800 mm/min to 24,000 mm/min, still more preferably from 1,200 mm/min to 15,000 mm/min.

### —Stretching Temperature—

While the polymer molded product may be stretched at any temperature suitably selected depending on the desired purpose, it is preferably stretched at a stretching temperature T(° C.) which falls within the following range:

(Tg−30)(° C.)≦T(° C.)≦(Tg+50)(° C.),

more preferably at a stretching temperature T(° C.) which falls within the following range:

(Tg−25)(° C.)≦T(° C.)≦(Tg+50)(° C.),

still more preferably at a stretching temperature T(° C.) which falls within the following range:

(Tg−20)(° C.)≦T(° C.)≦(Tg+50)(° C.)

where Tg denotes a glass transition temperature (° C.).

In general, a higher stretching temperature (° C.) results in a lower stretch tension, thus allowing the polymer molded product to be more easily stretched. However, a stretching temperature (° C.) that is equal to or higher than {glass transition temperature (Tg)−30}° C. but is equal to or lower than {glass transition temperature (Tg)+50}° C. is preferred since the void content is increased and voids having an aspect ratio of 10 or higher are likely to be formed in this temperature range, ensuring sufficient formation of voids.

The stretching temperature T(° C.) can be measured by a non-contact thermometer. The glass transition temperature Tg (° C.) can be measured by a differential scanning calorimeter (DSC).

During the stretching step, the polymer molded product may or may not be stretched in a transverse direction as long as the formation of voids is not hindered. The transverse stretching may be used to relax or thermally treat the film.

Once stretched, the void-containing resin molded product may be subjected to various treatments for the purpose of, for example, stabilizing its shape. For example, the void-containing resin molded product may be subjected to a heat treatment to cause thermal shrinkage or it may be treated to impart tension.

The polymer molded product may be produced by any suitable technique selected depending on the desired purpose. For example, it can be suitably produced by a melt film-forming process when the crystalline polymer is a polyester resin.

The production of the polymer molded product may be carried out independently of the above-described stretching step or may be sequentially carried out subsequent thereto.

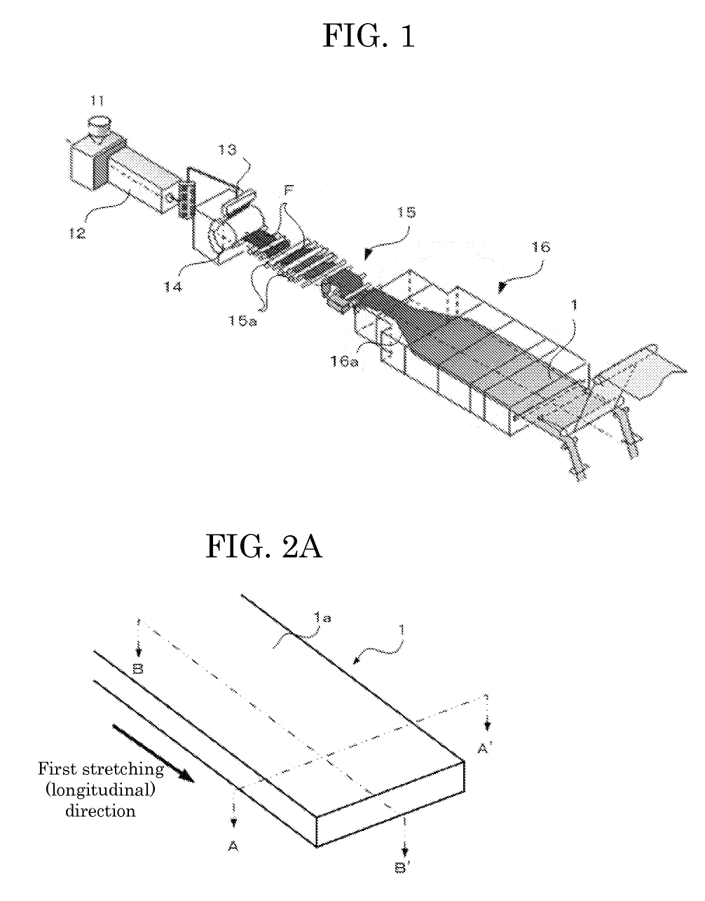

FIG. 1 is a flow diagram of a biaxial stretching film-forming apparatus, showing one example of a production method of void-formed resin molded products of the present invention.

As shown in FIG. 1, a raw resin material 11 is heat-melted and kneaded in an extruder 12 (either a biaxial extruder or a monoaxial extruder may be used depending on the form of the material and on the production scale) and then discharged from a T-die 13 in the form of a soft plate (a film or sheet).

The discharged film or sheet F is cooled and solidified on a casting roll 14 to form a film. The resulting film (i.e., polymer molded product) is sent to a longitudinal stretcher 15.

The film or sheet F is heated again in the longitudinal stretcher 15 and stretched longitudinally between rolls 15a being driven at different speeds. This longitudinal stretching results in void formation in the film or sheet F along the stretching direction. Subsequently, the film or sheet F having voids formed therein is stretched transversely as it travels in a transverse stretcher 16 to a winder (not shown) with its sides gripped by clips 16a arranged at either side of the transverse stretcher 16. This gives a void-formed resin molded product 1. In the above-described process, the longitudinally stretched film or sheet F may not be stretched with the traverse stretcher 16 and may directly be used as the void-formed resin molded product 1.

### <Applications>

The void-containing resin molded product of the present invention, which has high surface smoothness and has high heat insulation resulting from the above-described voids formed within the molded product, is highly suitable for use as an image-receiving film component or an image-receiving sheet component that can be used in a sublimation transfer recording material or a thermal transfer recording material. The void-containing resin molded product of the present invention can also be used as a heat insulation material in many other applications.

### (Image-Receiving Film or Sheet for Sublimation Transfer Recording Materials or Thermal Transfer Recording Materials)

The image-receiving film or sheet for use in a sublimation transfer recording material or a thermal transfer recording material preferably includes a dye-receiving layer (receiving layer) formed over a substrate, and an underlying layer formed between the receiving layer and the substrate. Examples of such an underlying layer include a whiteness-control layer, a charge-adjusting layer, a bonding layer and a primer layer. A heat insulation layer is preferably formed between the underlying layer and the substrate. The void-containing resin molded product (i.e., void-containing resin film or sheet) of the present invention is preferably used in the above-described heat insulation layer. The layers arranged between the substrate and the receiving layer are simply referred to as “intermediate layers,” among which are the above-described underlying layer and the heat insulation layer. The image-receiving film or sheet of the present invention for use in a sublimation transfer recording material or a thermal transfer recording material includes at least one receiving layer and at least one intermediate layer. A curl-adjusting layer, a writing layer and a charge-adjusting layer are preferably deposited on the back side of the substrate.

Details of the structure, constituents and production methods of the substrate, receiving layer, underlying layer and other layers may be found in, for example, JP-A No. 2007-30275.

Examples of techniques that can be used to form the above-described layers include gravure reverse coating, reverse (roll) coating, gravure coating, knife coating, blade coating, air knife coating, bill-blade coating, rotary screen coating, rod coating, bar coating, roll coating, gate roll coating, brush coating, spray coating, curtain coating, bead coating, slot orifice coating, die slot coating, die coating and extrusion coating.

### EXAMPLES

The present invention will next be described in more detail by way of examples, which should not be construed as limiting the present invention thereto. It should be appreciated that various changes may be made to the present invention without departing from the spirit of the previous and the following description, and that any of such changes falls within the scope of the present invention.

In the following, (void-containing) resin films that meet the requirements of the present invention (Examples 1 to 12) and resin films that do not meet the requirements of the present invention (Comparative Examples 1 to 4) are prepared and evaluated for their characteristics.

### Example 1

PBT1, a resin composed of polybutylene terephthalate only (100%) and having an IV of 0.72, was extruded from a T-die of a melt extruder at 245° C. and solidified on a casting drum to obtain a polymer film having a thickness of approximately 120 μm. The resulting polymer film was monoaxially (longitudinally) stretched.

Specifically, the polymer film was stretched monoaxially at a speed of 100 mm/min in an atmosphere maintained at 40° C. to induce necking. Once the occurrence of necking was confirmed, the polymer film was further monoaxially stretched in the same direction at a speed of 6,000 mm/min.

### Example 2

A resin film was prepared in the same manner as in Example 1, except that the polymer film had a thickness of approximately 50 μm and was stretched at 30° C., and the speed of longitudinal stretching in the second stretching step was 12,000 mm/min, rather than 6,000 mm/min.

### Example 3

PBT1, a resin composed of polybutylene terephthalate only (100%) and having an IV of 0.72, was extruded from a T-die of a melt extruder at 245° C. and solidified on a casting drum to obtain a polymer film having a thickness of approximately 100 μm. The resulting polymer film was monoaxially (longitudinally) stretched.

Specifically, the polymer film was stretched monoaxially at a speed of 2,400 mm/min in an atmosphere maintained at 40° C.

### Example 4

A resin film was prepared in the same manner as in Example 3, except that the speed of longitudinal stretching in the first stretching step was 8,000 mm/min, rather than 2,400 mm/min.

### Example 5

A resin film was prepared in the same manner as in Example 3, except that the speed of longitudinal stretching in the first stretching step was 11,000 mm/min, rather than 2,400 mm/min.

### Example 6

PBT1 used in Example 1 and PET having an IV of 0.67 (product of Fuji Photo Film Co., Ltd.) were mixed together at a ratio of 90:10 (=PBT1:PET). The mixture was extruded from a T-die of a melt extruder at 285° C. and solidified on a casting drum to obtain a polymer film having a thickness of approximately 55 μm. The resulting polymer film was monoaxially (longitudinally) stretched.

Specifically, the polymer film was stretched monoaxially at a speed of 100 mm/min in an atmosphere maintained at 60° C. to induce necking. Once the occurrence of necking was confirmed, the polymer film was further monoaxially stretched in the same direction at a speed of 4,000 mm/min.

### Example 7

PBT1 used in Example 1 and PET having an IV of 0.67 (product of Fuji Photo Film Co., Ltd.) were mixed together at a ratio of 95:5 (=PBT1:PET). The mixture was extruded from a T-die of a melt extruder at 285° C. and solidified on a casting drum to obtain a polymer film having a thickness of approximately 100 μm. The resulting polymer film was monoaxially (longitudinally) stretched.

Specifically, the polymer film was stretched monoaxially at a speed of 5,600 mm/min in an atmosphere maintained at 60° C.

### Example 8

PBT1 used in Example 1 and PET having an IV of 0.67 (product of Fuji Photo Film Co., Ltd.) were mixed together at a ratio of 80:20 (=PBT1:PET). The mixture was extruded from a T-die of a melt extruder at 285° C. and solidified on a casting drum to obtain a polymer film having a thickness of approximately 100 μm. The resulting polymer film was monoaxially (longitudinally) stretched.

Specifically, the polymer film was stretched monoaxially at a speed of 100 mm/min in an atmosphere maintained at 70° C. to induce necking. Once the occurrence of necking was confirmed, the polymer film was further monoaxially stretched in the same direction at a speed of 5,000 mm/min.

### Example 9

PBT2, a resin composed of polybutylene terephthalate only (100%) and having an IV of 0.86, was extruded from a T-die of a melt extruder at 250° C. and solidified on a casting drum to obtain a polymer film having a thickness of approximately 80 μm. The resulting polymer film was monoaxially (longitudinally) stretched.

Specifically, the polymer film was stretched monoaxially in a single step at a speed of 4,800 mm/min in an atmosphere maintained at 40° C.

### Example 10

PBS, a resin composed of polybutylene succinate only (100%) and having an IV of 0.67, was extruded from a T-die of a melt extruder at 175° C. and solidified on a casting drum to obtain a polymer film having a thickness of approximately 135 μm. The resulting polymer film was monoaxially (longitudinally) stretched.

Specifically, the polymer film was stretched monoaxially at a speed of 100 mm/min in an atmosphere maintained at 15° C. to induce necking. Once the occurrence of necking was confirmed, the polymer film was further monoaxially stretched in the same direction at a speed of 6,000 mm/min.

### Example 11

A resin film was prepared in the same manner as in Example 10, except that the polymer film had a thickness of approximately 100 μm, the speed of longitudinal stretching in the first stretching step was 4,800 mm/min, rather than 100 mm/min, and the second stretching step was not performed.

### Example 12

PHT, a resin composed of polyhexamethylene terephthalate only (100%) and having an IV of 0.70, was extruded from a T-die of a melt extruder and solidified on a casting drum to obtain a polymer film having a thickness of approximately 100 μm. The resulting polymer film was monoaxially (longitudinally) stretched.

Specifically, the polymer film was stretched monoaxially at a speed of 5,200 mm/min in an atmosphere maintained at 20° C.

### Comparative Example 1

A resin film was prepared in the same manner as in Example 1, except that the polymer film was stretched at 5° C., rather than 40° C.

In Comparative Example 1, the polymer film tore immediately after the first longitudinal stretching step was started.

### Comparative Example 2

A resin film was prepared in the same manner as in Example 1, except that the polymer film was stretched at 100° C., rather than 40° C.

In Comparative Example 2, the occurrence of necking was not observed after the first longitudinal stretching step, nor were any voids formed in the second stretching step.

### Comparative Example 3

A resin film was prepared in the same manner as in Example 1, except that the speed of longitudinal stretching in the first stretching step was 40,000 mm/min, rather than 100 mm/min.

In Comparative Example 3, the polymer film tore immediately after the first longitudinal stretching step was started.

### Comparative Example 4

CRISPER VOID PET (K2323) (product of TOYOBO CO. LTD.) was used as the resin film.

The resin films prepared/obtained in Examples 1 to 12 and Comparative Examples 1 to 4 are collectively shown in Tables 1 and 2.

TABLE 1

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Material | Resins | PBT1 | PBT1 | PBT1 | PBT1 | PBT1 | PBT1/PET | PBT1/PET | PBT1/PET |
| | | | | | | | (90/10) | (95/5) | (80/20) |
| | | | | | | | (% by mass) | (% by mass) | (% by mass) |
| | Tg (° C.) | 39 | 39 | 39 | 39 | 39 | 39/72 | 39/72 | 39/72 |
| | Void-forming | None | None | None | None | None | None | None | None |
| | components | | | | | | | | |
| | other than | | | | | | | | |
| | crystalline | | | | | | | | |
| | polymer | | | | | | | | |
| | IV | 0.72 | 0.72 | 0.72 | 0.72 | 0.72 | 0.72/0.67 | 0.72/0.67 | 0.72/0.67 |
| | Tm (° C.) | 228 | 228 | 228 | 228 | 228 | 228/268 | 228/268 | 228/268 |
| Polymer | Thickness | 120 | 50 | 100 | 100 | 100 | 55 | 100 | 100 |
| film | (μm) | | | | | | | | |
| Stretch | First | 100 | 100 | 2,400 | 8,000 | 11,000 | 100 | 5,600 | 100 |
| | stretching | | | | | | | | |
| | speed (mm/min) | | | | | | | | |
| | Second | 6,000 | 12,000 | — | — | — | 4,000 | — | 5,000 |
| | stretching | | | | | | | | |
| | speed (mm/min) | | | | | | | | |
| | Stretching | 40 | 30 | 40 | 40 | 40 | 60 | 60 | 70 |
| | temp. (° C.) | | | | | | | | |

TABLE 2

| | | | | | | Comp. | Comp. | Comp. | Comp. |
|---|---|---|---|---|---|---|---|---|---|
| | | Ex. 9 | Ex. 10 | Ex. 11 | Ex. 12 | Ex. 1 | Ex. 2 | Ex. 3 | Ex. 4 |
| Material | Resins | PBT2 | PBS | PBS | PHT | PBT1 | PBT1 | PBT1 | CRISPER |
| | | | | | | | | | VOID PET |
| | | | | | | | | | (K2323) |
| | Tg (° C.) | 39 | −30 | −30 | 20 | 39 | 39 | 39 | N/A |
| | Void-forming | None | None | None | None | None | None | None | Inorganic |
| | components | | | | | | | | particles |
| | other than | | | | | | | | |
| | crystalline | | | | | | | | |
| | polymer | | | | | | | | |
| | IV | 0.86 | 0.67 | 0.67 | 0.70 | 0.72 | 0.72 | 0.72 | N/A |
| | Tm (° C.) | 228 | 110 | 110 | 152 | 228 | 228 | 228 | N/A |
| Polymer | Thickness | 80 | 135 | 100 | 100 | 30 | 130 | 80 | N/A |
| film | (μm) | | | | | | | | |
| Stretch | First | 4,800 | 100 | 4,800 | 5,200 | 100 | 100 | 40,000 | N/A |
| | stretching | | | | | | | | |
| | speed (mm/min) | | | | | | | | |
| | Second | — | 6,000 | — | — | — | 6,000 | — | N/A |
| | stretching | | | | | | | | |
| | speed (mm/min) | | | | | | | | |
| | Stretching | 40 | 15 | 15 | 20 | 5 | 100 | 40 | N/A |
| | temp. (° C.) | | | | | | | | |

### —Evaluation—

The resin films of Examples 1 to 12 and Comparative Examples 1 to 4 were evaluated as follows.

### (1) Thickness

The thickness was measured using a long-range contact-type displacement sensor including AF030 (detector unit) and AF350 (indicator unit) (product of KEYENCE CORPORATION).

### (2) Thermal Conductivity

The thermal diffusivity was measured by TC-7000 (product of The Optronics, Co., Ltd.). Specifically, each resin film was sprayed black on either side and measurements were taken at room temperature. The density and the specific heat were measured by the techniques described below. The thermal conductivity was then determined as the product of the three values.

### (3) Density

A portion having a predetermined area was cut out from each resin film and was weighed on a balance. The thickness of the portion was measured by a film thickness meter. The mass was then divided by the volume of the portion to give the density.

### (4) Specific Heat

The specific heat was determined according to the technique described in JIS K7123. The DSC used was Q1000 (TA Instruments).

### (5) Surface Smoothness

The surface smoothness was measured on NewView 5022 interferometer (Zygo) for three-dimensional profiling at an objective magnification of ×50.

### (6) Void Content

The void content was calculated based on the measured specific gravity of each resin film.

Specifically, the void content was calculated by the following equation (1):

Void content (%)={1−(density of resin film after stretching)/(density of resin film before stretching)} (1)

### (7) Aspect Ratio

A cross-section perpendicular both to the surface of each resin film and to the direction of longitudinal stretching (see FIG. 2B) and a cross-section perpendicular to the surface of the resin film and parallel to the direction of longitudinal stretching (see FIG. 2C) were observed by a scanning electron microscope at a suitable magnification between ×300 to ×3,000. A measurement frame was selected in each cross-sectional photograph so that 50 to 100 voids were contained in the frame. The longitudinal alignment of voids was also confirmed by the observation with a scanning electron microscope.

The number of voids contained in each measurement frame was counted: the number of voids contained in a given measurement frame in a cross-section perpendicular to the longitudinal stretching direction (see FIG. 2B) was designated “m” and the number of voids contained in a given measurement frame in a cross-section parallel to the longitudinal stretching direction (see FIG. 2C) was designated “n.”

The thickness (rᵢ) of each void contained in the analysis measurement in the cross-section perpendicular to the longitudinal stretching direction (see FIG. 2B) was then measured and the average thickness was designated “r.” The length (Lᵢ) of each void contained in the measurement frame in the cross-section parallel to the longitudinal stretching direction (see FIG. 2C) was also measured and the average length was designated “L.”

Thus, r and L can be expressed by the following equations (2) and (3), respectively:

r=(Σrᵢ)/m (2)

L=(ΣLᵢ)/n (3)

The aspect ratio can then be determined as L/r.

### (8) Evaluation of Printing Quality

### —Preparation of Image-Receiving Sheet for Thermal Transfer Recording—

First, image-receiving sheets for thermal transfer recording were prepared by subjecting the surface of each of the resin films of Examples 1 to 12 and Comparative Examples 1 to 4 to different treatments as described below.

A paper substrate laminated with polyethylene on either side was treated with corona discharge and a gelatin base layer containing sodium dodecyl benzene sulfonate was deposited on the substrate. Each of the resin films of Examples 1 to 12 and Comparative Examples 1 to 4 was then heat-laminated to one surface of the substrate to serve as a heat insulation layer. Subsequently, a white intermediate layer and a receiving layer having the respective compositions given below were sequentially applied using a bar coater. The white intermediate layer and the receiving layer were applied in amounts after drying of 1.0 g/m² and 4.0 g/m², respectively. Each layer was dried at 110° C. for 30 seconds.

--White intermediate layer--

| | | |
|---|---|---|
| Polyester resin (product name BYLON 200, | 10 | parts by mass |
| manufactured by TOYOBO CO. LTD.) | | |
| Optical brightening agent (product name | 1 | part by mass |
| UVITEX OB, manufactured by Ciba-Geigy K.K.) | | |
| Titanium oxide | 30 | parts by mass |
| Methyl ethyl ketone/toluene (1/1) | 90 | parts by mass |

--Receiving layer--

| | | |
|---|---|---|
| Vinyl chloride/vinyl acetate resin | 100 | parts by mass |
| (product name SOLBIN A, manufactured by | | |
| Nissin Chemical Industry) | | |
| Amino-modified silicone | 5 | parts by mass |
| (product name X22-3050C, manufactured by | | |
| Shin-Etsu Chemical) | | |
| Epoxy-modified silicone | 5 | parts by mass |
| (product name X22-300E, manufactured by | | |
| Shin-Etsu Chemical) | | |
| Methyl ethyl ketone/toluene (=1/1) | 400 | parts by mass |
| Benzotriazole-based UV absorber | 5 | parts by mass |
| (product name TINUVIN 900, manufactured by | | |
| Ciba Specialty Chemicals) | | |

### —Printing Method—

Next, FUJIX VP8100 color printer manufactured by Fuji Photo Film Co., Ltd. was loaded with an exclusive ribbon and was used for printing test of the receiving layer surface of the image-receiving sheet for thermal transfer recording. Panelists were asked to evaluate the printed image in a sensory test. Each of the image-receiving sheets for thermal transfer recording was lined with high-quality paper (approx. 130 μm thick) prior to the test.

### —Evaluation Criteria—

The following evaluation criteria were used in the sensory test:

A: Thick printed image, and high sensitivity.

B: Thick printed image, but normal sensitivity.

C: Thin printed image, and low sensitivity.

TABLE 3

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Appearance of | Opaque | Opaque | Opaque | Opaque | Opaque | Opaque | Opaque | Opaque |
| stretched film | | | | | | | | |
| Thickness (μm) | 80 | 30 | 100 | 80 | 60 | 30 | 30 | 40 |
| Thermal conductivity | 0.031 | 0.029 | 0.024 | 0.055 | 0.037 | 0.063 | 0.058 | 0.060 |
| of stretched film X | | | | | | | | |
| (W/mK) | | | | | | | | |
| Thermal conductivity | 0.35 | 0.35 | 0.35 | 0.35 | 0.35 | 0.35/0.218 | 0.35/0.218 | 0.35/0.218 |
| of polymer film | | | | | | | | |
| having the same | | | | | | | | |
| thickness as stretched | | | | | | | | |
| film Y (W/mK) | | | | | | | | |
| X/Y | 0.09 | 0.08 | 0.07 | 0.15 | 0.10 | 0.18 | 0.17 | 0.17 |
| Density | 1.01 | 1.03 | 1.10 | 1.08 | 1.06 | 1.11 | 1.09 | 1.09 |
| Specific heat | 1.07 | 1.07 | 1.07 | 1.07 | 1.08 | 1.08 | 1.09 | 1.09 |
| Surface smoothness | 0.08 | 0.08 | 0.09 | 0.08 | 0.09 | 0.08 | 0.09 | 0.09 |
| (Ra) | | | | | | | | |
| Void content (Vol %) | 22 | 20 | 18 | 18 | 20 | 16 | 17 | 14 |
| Average void | 0.83 | 0.76 | 0.81 | 0.81 | 0.83 | 0.62 | 0.62 | 0.61 |
| thickness r (μm) | | | | | | | | |
| Average void | 12.5 | 22.2 | 12.1 | 15.1 | 20.2 | 14.3 | 14.1 | 14.2 |
| length L (μm) | | | | | | | | |
| L/r | 15 | 30 | 15 | 19 | 24 | 23 | 23 | 23 |
| Printing quality | A | A | B | B | B | B | B | B |

TABLE 4

| | | | | | Comp. | Comp. | Comp. | Comp. |
|---|---|---|---|---|---|---|---|---|
| | Ex. 9 | Ex. 10 | Ex. 11 | Ex. 12 | Ex. 1 | Ex. 2 | Ex. 3 | Ex. 4 |
| Appearance of | Opaque | Opaque | Opaque | Opaque | Torn | Clear | Torn | Opaque |
| stretched film | | | | | | | | |
| Thickness (μm) | 50 | 90 | 50 | 80 | — | 41 | — | 75 |
| Thermal conductivity | 0.050 | 0.040 | 0.054 | 0.032 | — | 0.330 | — | 0.061 |
| of stretched film X | | | | | | | | |
| (W/mK) | | | | | | | | |
| Thermal conductivity | 0.35 | 0.29 | 0.29 | 0.32 | 0.35 | 0.35 | 0.35 | 0.218 |
| of polymer film | | | | | | | | (PET only) |
| having the same | | | | | | | | |
| thickness as stretched | | | | | | | | |
| film Y (W/mK) | | | | | | | | |
| X/Y | 0.14 | 0.14 | 0.19 | 0.10 | — | 0.94 | — | 0.28 |
| Density | 1.08 | 1.09 | 1.06 | 1.08 | — | 1.29 | — | 1.13 |
| Specific heat | 1.07 | 1.05 | 1.05 | 1.07 | — | 1.07 | — | 1.01 |
| Surface smoothness | 0.09 | 0.09 | 0.09 | 0.08 | — | 0.08 | — | 0.33 |
| (Ra) | | | | | | | | |
| Void content (Vol %) | 14 | 18 | 17 | 22 | — | none | — | N/A |
| Average void | 0.62 | 0.82 | 0.75 | 0.81 | — | none | — | 0.8 |
| thickness r (μm) | | | | | | | | |
| Average void | 18.9 | 10.2 | 10.3 | 14.3 | — | none | — | 10.6 |
| length L (μm) | | | | | | | | |
| L/r | 12 | 12 | 14 | 18 | — | — | — | 13 |
| Printing quality | B | B | B | B | — | C | — | B |

The results of these examples indicate that each of the void-containing resin molded products of the present invention exhibits low thermal conductivity that is significantly decreased from the thermal conductivity measured prior to stretching (as indicated by small X/Y ratio). This is considered to be because the voids formed within the void-containing resin molded products of the present invention are formed only of crystalline polymer and contain no void-forming agents, such as thermoplastic resins and inorganic particles, that serve to increase thermal conductivity.

The unexpected observation that voids are formed only within the void-containing resin molded product explains high surface smoothness. It has been demonstrated that these physical properties contribute to highly favorable printing characteristics.

The results of Comparative Examples 1 to 3 indicate that void-containing resin molded products of the present invention cannot be produced from the same resin if the conditions for stretching are not suitable. The image-receiving sheets for thermal transfer recording prepared in Examples were cut and the SEM photograph of the cross-section was observed to reveal that the voids were maintained within the heat insulation layer of each of the image-receiving sheets for thermal transfer recording prepared using the resin films of Examples 1 to 12.

1. A void-containing resin molded product consisting of:
a crystalline polymer,
wherein the void-containing resin molded product has voids therein, and has a ratio X/Y of 0.27 or less, where X denotes a thermal conductivity (in W/mK) of the void-containing resin molded product, and Y denotes a thermal conductivity (in W/mK) of a void-free polymer molded product having the same thickness as the void-containing resin molded product and consisting of the same crystalline polymer that forms the void-containing resin molded product.

2. The void-containing resin molded product according to claim 1, wherein the void-containing resin molded product has a thermal conductivity of 0.1 (W/mK) or less.

3. The void-containing resin molded product according to claim 1, wherein the void-containing resin molded product has a void content of 3 vol % to 50 vol % and has a ratio L/r of 10 or greater, where L denotes an average length (in μm) of the voids in a direction in which the voids are aligned, and r denotes an average length (in μm) of the voids in a thickness direction of the void-containing resin molded product, which direction is perpendicular to the direction in which the voids are aligned.

4. The void-containing resin molded product according to claim 1, wherein the void-containing resin molded product consists of at least one type of the crystalline polymer, and the at least one type of the crystalline polymer has two or more different crystalline states.

5. The void-containing resin molded product according to claim 1, wherein the resin molded product consists of one type of the crystalline polymer.

6. The void-containing resin molded product according to claim 1, wherein the crystalline polymer is a polyester.

7. The void-containing resin molded product according to claim 1, wherein the voids are formed by stretching a polymer molded product consisting of the crystalline polymer at a speed of 10 mm/min to 36,000 mm/min and at a stretching temperature T(° C.) which falls within the following range:
(Tg−30)(° C.)≦T(° C.)≦(Tg+50)(° C.)
where Tg denotes a glass transition temperature (° C.) of the crystalline polymer.

8. A method for producing a void-containing resin molded product, the method comprising:
stretching a polymer molded product consisting of a crystalline polymer at a speed of 10 mm/min to 36,000 mm/min and at a stretching temperature T(° C.) which falls within the following range:
(Tg−30)(° C.)≦T(° C.)≦(Tg+50)(° C.)
where Tg denotes a glass transition temperature (° C.) of the crystalline polymer,
wherein the void-containing resin molded product consists of a crystalline polymer,
wherein the void-containing resin molded product has voids therein, and has a ratio X/Y of 0.27 or less, where X denotes a thermal conductivity (in W/mK) of the void-containing resin molded product, and Y denotes a thermal conductivity (in W/mK) of a void-free polymer molded product having the same thickness as the void-containing resin molded product and consisting of the same crystalline polymer that forms the void-containing resin molded product.

9. An image-receiving film or sheet for a sublimation transfer recording material or a thermal transfer recording material, the film or sheet comprising:
a void-containing resin molded product,
wherein the void-containing resin molded product consists of a crystalline polymer,
wherein the void-containing resin molded product has voids therein, and has a ratio X/Y of 0.27 or less, where X denotes a thermal conductivity (in W/mK) of the void-containing resin molded product, and Y denotes a thermal conductivity (in W/mK) of a void-free polymer molded product having the same thickness as the void-containing resin molded product and consisting of the same crystalline polymer that forms the void-containing resin molded product.
